(19) United States
(12) Patent Application Publication
(10) Pub. No.: US 2015/0193847 A1
(43) Pub. Date: Jul. 9, 2015

(54) MERCHANDISE SALES PROCESSING SYSTEM

(71) Applicant: DeNA Co., Ltd., Tokyo (JP)

(72) Inventors: Takashi OHKUBO, Tokyo (JP); Yusuke SUMAKI, Tokyo (JP)

(21) Appl. No.: 14/524,057

(22) Filed: Oct. 27, 2014

(30) Foreign Application Priority Data
Jan. 8, 2014 (JP) 2014-001928

(51) Int. Cl. G06Q 30/06; G06Q 30/02

(52) U.S. Cl. CPC G06Q 30/0601; G06Q 30/0222

(57) ABSTRACT

A merchandise sales processing system includes a presentation processing unit that presents a shopping bag frame having a predetermined shape corresponding to blocks, and merchandise pieces respectively associated with merchandise items, each of the merchandise pieces corresponding to a predetermined number of the blocks and having a predetermined shape unrelated to the corresponding merchandise item; a merchandise piece arrangement processing unit that receives, from a purchaser, a request to arrange one of the merchandise pieces at a predetermined position to which no other merchandise pieces are arranged in the shopping bag frame, and arranges one of the merchandise pieces at the predetermined position when a shape of the merchandise piece matches a shape of the predetermined position; and a sales processing unit that performs a sales process for the merchandise items associated with the merchandise pieces arranged in the shopping bag frame.

### CROSS-REFERENCE TO RELATED APPLICATION

The present application is based on and claims the benefit of priority of Japanese Priority Application No. 2014-001928 filed on Jan. 8, 2014, the entire contents of which are hereby incorporated by reference.

### BACKGROUND OF THE INVENTION

1. Field of the Invention

The present invention relates to a merchandise sales processing system.

2. Description of the Related Art

Conventionally, there are the following methods of selling merchandise in a retail storefront. One example is a “lucky bag”, by which each bag is priced at, for example, 1000 yen and sold without revealing what is contained in the bag. Another example is “unlimited packing”, by which the customer can pack a bag or a box with as many merchandise items as may fit in the bag or box, and the price is fixed in units of bags or boxes. These methods have an aspect of having the customer enjoy the process of purchasing merchandise.

In online shopping, for example, Patent Documents 1 and 2 describe a technology of arbitrarily creating a gift box merchandise item on the Internet.

Patent Document 3 describes a technology in which, when the customer drops one of the merchandise item image information items on a bag image information item, the sum of virtual volume information items corresponding to the dropped merchandise items is compared with the upper limit value of the virtual capacity information of the bag. When the sum of the virtual volume information items is less than or equal to the upper limit value, inflated bag image information and settlement display information are displayed. When the sum of the virtual volume information items exceeds the upper limit value, broken bag image information is displayed. The virtual volume information and the virtual capacity information are not known to the customer. This method enables the customer to purchase merchandise items at a comparatively cheap price, by packing the bag with merchandise items having a low value of the virtual volume information and a high price.

Patent Document 1: Japanese Laid-Open Patent Publication No. 2002-24584

Patent Document 2: Japanese Laid-Open Patent Publication No. 2002-24638

Patent Document 3: Japanese Laid-Open Patent Publication No. 2009-94978

However, there has been room for improvement in online shopping in terms of having the customer enjoy the process of purchasing merchandise items. For example, in the technology described in Patent Documents 1 and 2, the customer is merely able to select the merchandise item to be put in a gift box. Furthermore, in the technology described in Patent Document 3, the virtual volume information and the virtual capacity information are not known to the customer, and therefore the method is supposed to provide the customer with the sense of shopping like playing a game. However, because the virtual volume information and the virtual capacity information are not known to the customer, there is a limited number of ways by which the customer can attempt to purchase merchandise items at a comparatively cheap price.

### SUMMARY OF THE INVENTION

The present invention is made in light of the above problems, and provides a technique capable of providing the customer with enjoyment in the process of purchasing merchandise when shopping online.

According to an embodiment, there is provided a merchandise sales processing system including a presentation processing unit that presents a shopping bag frame having a predetermined shape corresponding to a plurality of blocks, and a plurality of merchandise pieces respectively associated with merchandise items, each of the plurality of merchandise pieces corresponding to a predetermined number of the plurality of blocks and having a predetermined shape unrelated to the corresponding merchandise item; a merchandise piece arrangement processing unit that receives, from a purchaser, a request to arrange one of the plurality of merchandise pieces at a predetermined position to which no other ones of the plurality of merchandise pieces are arranged in the shopping bag frame, and arranges the one of the plurality of merchandise pieces at the predetermined position when a shape of the one of the plurality of merchandise pieces matches a shape of the predetermined position; and a sales processing unit that performs a sales process for at least one of the merchandise items associated with at least one of the plurality of merchandise pieces arranged in the shopping bag frame.

Note also that arbitrary combinations of the above-described elements, and any changes of expressions in the present invention, made among methods, devices, systems, recording media, computer programs and so forth, are valid as embodiments of the present invention.

### BRIEF DESCRIPTION OF THE DRAWINGS

Other objects, features and advantages of the present invention will become more apparent from the following detailed description when read in conjunction with the accompanying drawings.

FIG. 1 is a block diagram illustrating an example of a network structure of an embodiment;

FIG. 2 is a block diagram illustrating an example of a hardware structure of a user terminal device of the embodiment;

FIG. 3 is a block diagram illustrating an example of a hardware structure of a merchandise sales processing system of the embodiment;

FIG. 4 is a block diagram illustrating a functional structure of the user terminal device and the merchandise sales processing system of the embodiment;

FIG. 5 illustrates an example of a merchandise sales screen of the embodiment;

FIG. 6 illustrates another example of the merchandise sales screen of the embodiment;

FIG. 7 illustrates an example of the internal structure of a merchandise information storing unit of the embodiment;

FIG. 8 illustrates an example of the internal structure of a merchandise piece storing unit of the embodiment;

FIG. 9 illustrates an example of the internal structure of a shopping bag frame storing unit 66 of the embodiment;

FIG. 10 illustrates an example of the internal structure of a user information storing unit of the embodiment;

FIG. 11 illustrates another example of the merchandise sales screen of the embodiment;

FIG. 12 illustrates another example of the merchandise sales screen of the embodiment;

FIG. 13 illustrates another example of the merchandise sales screen of the embodiment;

FIG. 14 illustrates another example of the merchandise sales screen of the embodiment;

FIG. 15 illustrates another example of the merchandise sales screen of the embodiment;

FIG. 16 illustrates another example of the merchandise sales screen of the embodiment;

FIG. 17 is a flowchart of an example of processing procedures of the merchandise sales processing system of the embodiment;

FIG. 18 illustrates another example of the merchandise sales screen of the embodiment;

FIG. 19 illustrates another example of the merchandise sales screen of the embodiment;

FIG. 20 illustrates another example of the merchandise sales screen of the embodiment;

FIG. 21 illustrates another example of the merchandise sales screen of the embodiment; and

FIG. 22 illustrates another example of the merchandise sales screen of the embodiment.

### DETAILED DESCRIPTION OF THE PREFERRED EMBODIMENTS

The invention will be described herein with reference to illustrative embodiments. Those skilled in the art will recognize that many alternative embodiments can be accomplished using the teachings of the present invention and that the invention is not limited to the embodiments illustrated for explanatory purposes.

It is to be noted that, in the explanation of the drawings, the same components are given the same reference numerals, and explanations are not repeated.

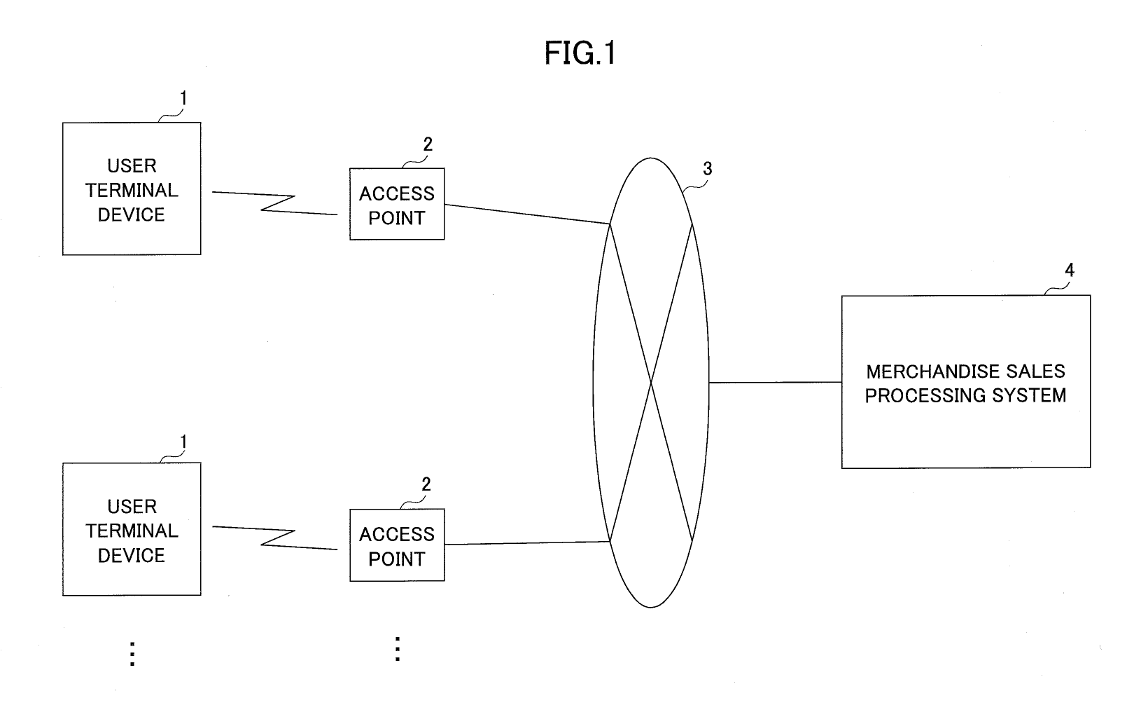

FIG. 1 is a block diagram illustrating an example of a network structure of the embodiment.

The network structure includes a user terminal device 1 operated by a user, an access point 2 such as a mobile wireless base station and a Wi-Fi station, a network 3 such as the Internet, and a merchandise sales processing system 4 for performing a process (control) of selling merchandise. The merchandise sales processing system 4 is connected to a plurality of user terminal devices 1 via the network 3. The user terminal device 1 is an information processing device such as a mobile phone, a smartphone, a game console, a personal computer, a touch pad, and an electronic book reader.

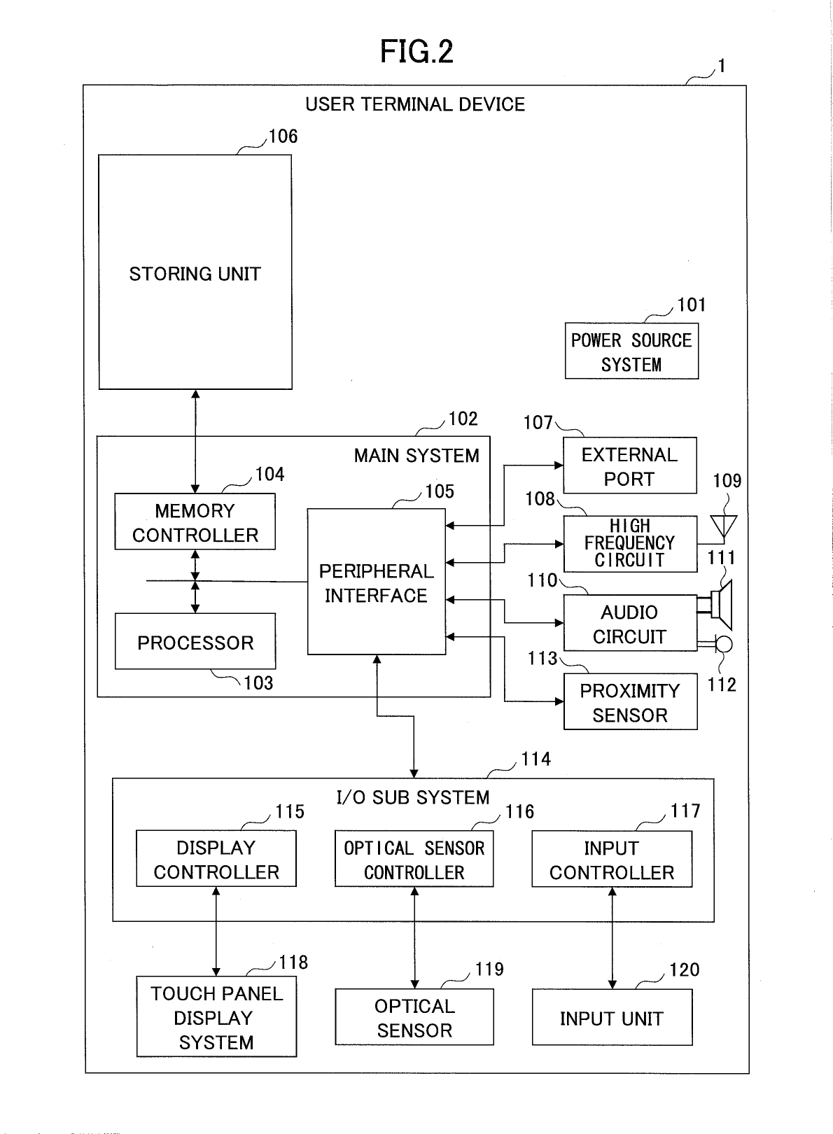

FIG. 2 is a block diagram illustrating an example of a hardware structure of the user terminal device 1 of the embodiment.

The user terminal device 1 includes a power source system 101, a main system 102, a storing unit 106, an external port 107, a high frequency circuit 108, an antenna 109, an audio circuit 110, a speaker 111, a microphone 112, a proximity sensor 113, an I/O (Input/Output) sub system 114, a touch panel display system 118, an optical sensor 119 and an input unit 120. The main system 102 includes a processor 103, a memory controller 104, and a peripheral interface 105. The I/O sub system 114 includes a display controller 115, an optical sensor controller 116, and an input controller 117.

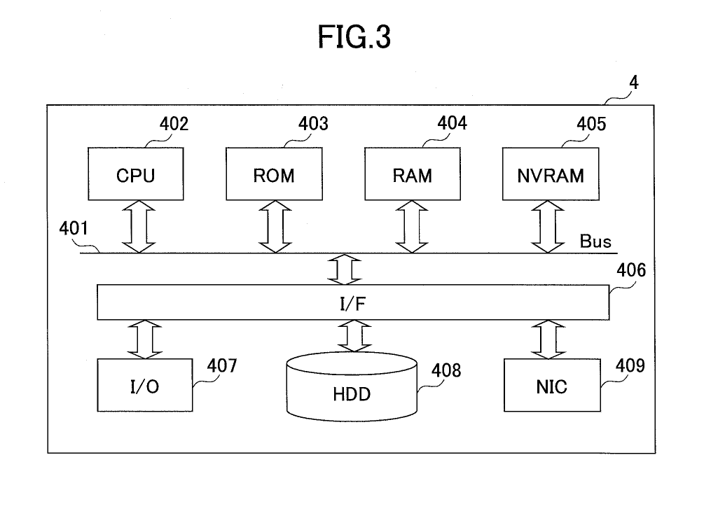

FIG. 3 is a block diagram illustrating an example of a hardware structure of the merchandise sales processing system 4 of the embodiment.

The merchandise sales processing system 4 includes a CPU (Central Processing Unit) 402, a ROM (Read Only Memory) 403, a RAM (Random Access Memory) 404, an NVRAM (Non-Volatile Random Access Memory) 405, and an I/F (Interface) 406 connected to a system bus 401, an I/O (Input/Output device) 407 for a keyboard, a mouse, a monitor, a CD/DVD (Compact Disk/Digital Versatile Disk) drive or the like, an HDD (Hard Disk Drive) 408 and an NIC (Network Interface Card) 409 connected to the I/F 406.

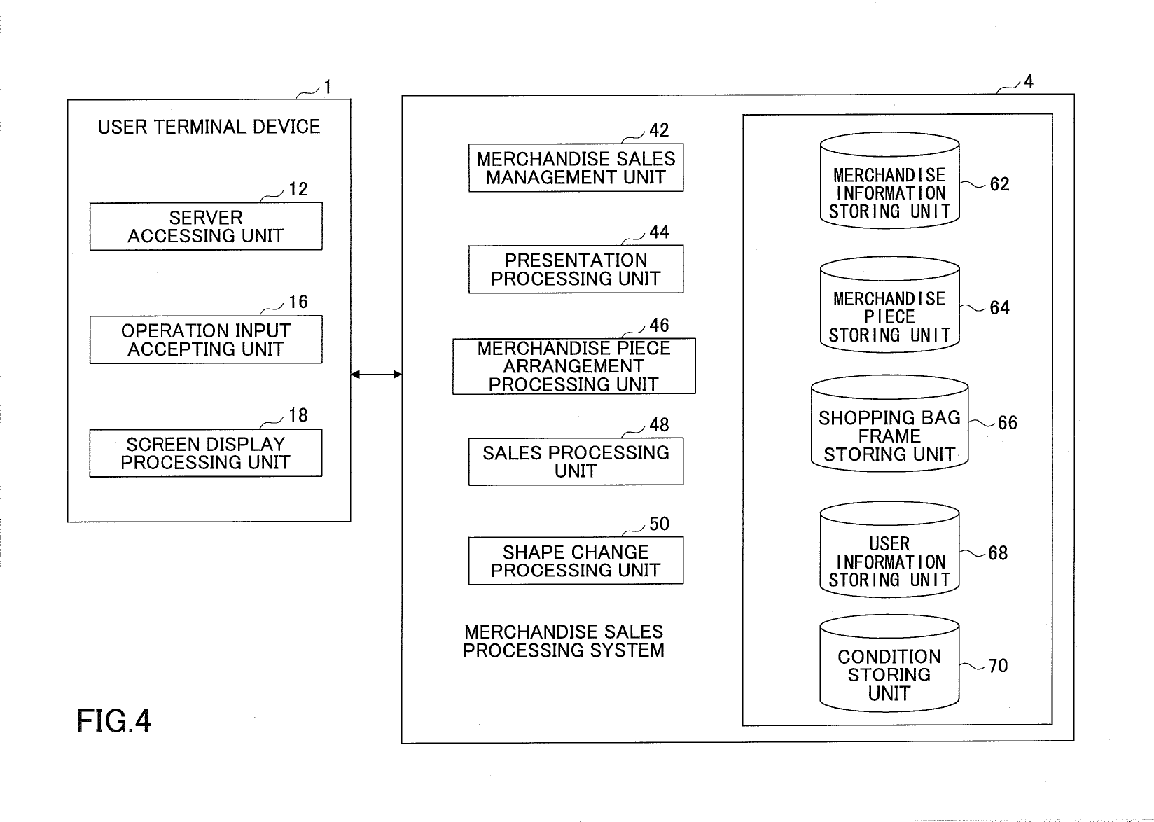

FIG. 4 is a block diagram illustrating a functional structure of the user terminal device 1 and the merchandise sales processing system 4 of the embodiment.

The user terminal device 1 includes a server accessing unit 12, an operation input accepting unit 16, and a screen display processing unit 18. The operation input accepting unit 16 accepts an operation input of a user that operates the user terminal device 1. The server accessing unit 12 sends a request to the merchandise sales processing system 4 and receives a processed result or the like as a response from the merchandise sales processing system 4 when it is necessary to access the merchandise sales processing system 4 in a course of the processing. The screen display processing unit 18 displays screens.

The merchandise sales processing system 4 includes a merchandise sales management unit 42, a presentation processing unit 44, a merchandise piece arrangement processing unit 46, a sales processing unit 48, a shape change processing unit 50, a merchandise information storing unit 62, a merchandise piece storing unit 64, a shopping bag frame storing unit 66, a user information storing unit 68, and a condition storing unit 70.

The merchandise sales management unit 42 controls the entirety of the merchandise sales processing system 4. The presentation processing unit 44 provides a merchandise sales screen to the purchaser.

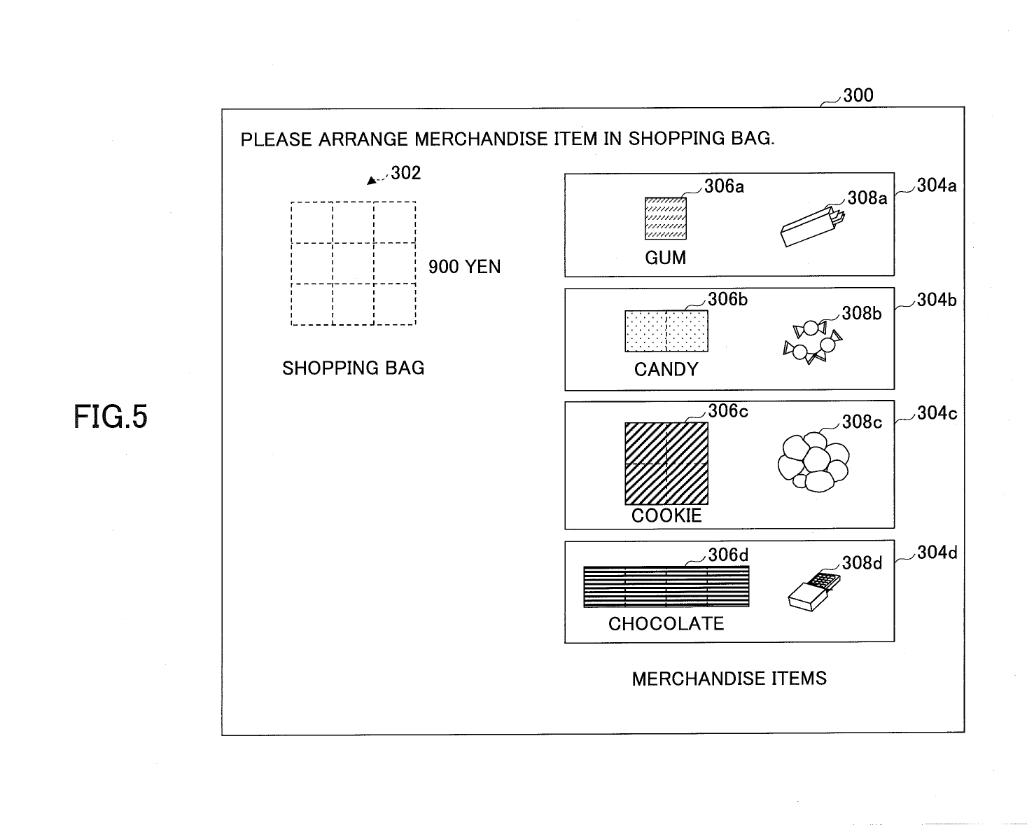

FIG. 5 illustrates an example of a merchandise sales screen 300 provided by the presentation processing unit 44 of the embodiment.

The merchandise sales screen 300 includes a shopping bag frame 302 having a predetermined shape corresponding to a plurality of blocks, and merchandise information items 304a through 304d of a plurality of merchandise items that are sold. In the illustrated example, the shopping bag frame 302 has a shape where nine blocks are arranged in a three-by-three matrix.

The merchandise information items 304a through 304d include merchandise pieces 306a through 306d and merchandise images 308a through 308d, respectively. The merchandise images 308a through 308d are images of merchandise items. For example, if the merchandise item is chocolate, the merchandise images 308a through 308d are images of chocolate. Meanwhile, the merchandise pieces 306a through 306d are respectively associated with merchandise items, each being expressed by a predetermined number of blocks and having a predetermined shape that is unrelated to the corresponding merchandise item.

In the illustrated example, an item piece 306a is associated with gum, and has a shape corresponding to one block. The item piece 306b is associated with candy, and has a shape corresponding to two blocks. The item piece 306c is associated with cookies, and has a shape corresponding to three blocks. The item piece 306d is associated with chocolate, and has a shape corresponding to four blocks. Note that in the example illustrated in FIG. 5, the merchandise images 308a through 308d are respectively juxtaposed to the merchandise pieces 306a through 306d; however, the merchandise images 308a through 308d may be respectively displayed above the corresponding merchandise pieces 306a through 306d.

In the above configuration, the purchaser who wants to purchase a merchandise item selects the merchandise piece (for example, the merchandise piece 306c) of the merchandise item he/she wants to purchase, and arranges the selected merchandise piece in a predetermined position in the shopping bag frame 302 where no other merchandise pieces are arranged yet. For example, this operation can be performed by the purchaser by clicking and dragging the merchandise piece 306c in the merchandise sales screen 300, and dropping the merchandise piece 306c at a predetermined position in the shopping bag frame 302. Furthermore, the merchandise pieces 306a through 306d may be rotated by an operation by the purchaser.

Referring back to FIG. 4, the merchandise piece arrangement processing unit 46 receives, from the purchaser via the user terminal device 1, a request to arrange a merchandise piece at a predetermined position where no other merchandise pieces are arranged yet, in the shopping bag frame 302. The merchandise piece arrangement processing unit 46 arranges a merchandise piece at a predetermined position, when the shape of the merchandise piece matches the shape of the predetermined position.

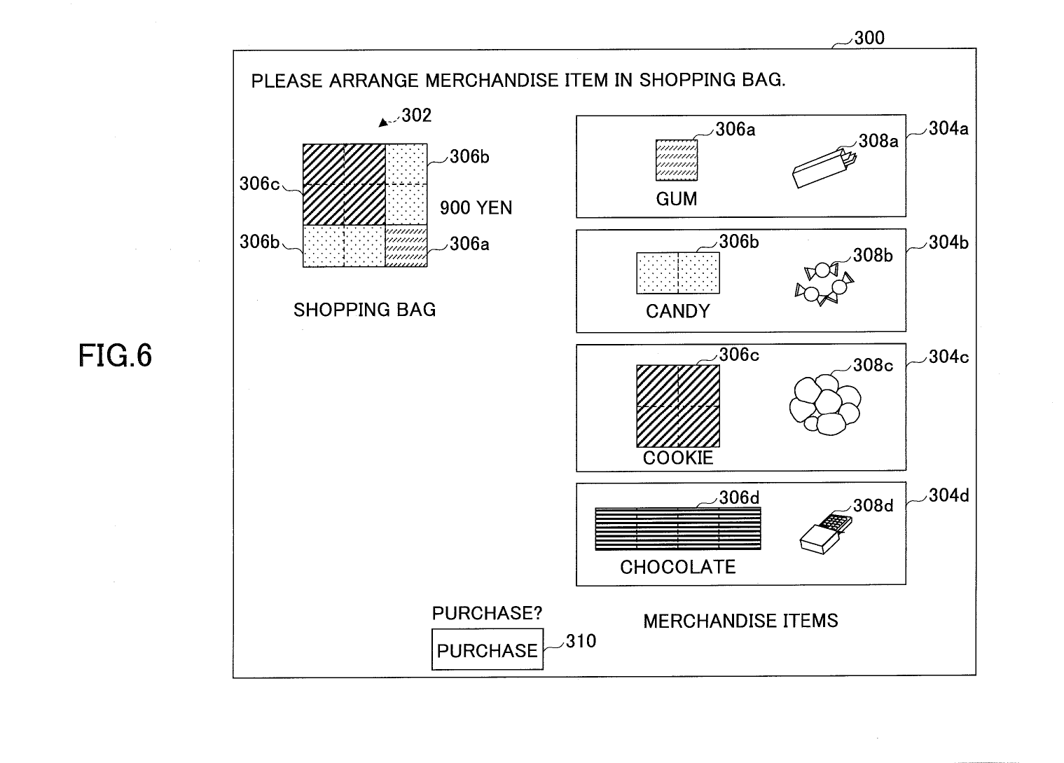

FIG. 6 illustrates a state of the merchandise sales screen 300 illustrated in FIG. 5, where a plurality of merchandise pieces are arranged in the shopping bag frame 302. In this example, one merchandise piece 306a associated with gum, two merchandise pieces 306b associated with candy, and one merchandise piece 306c associated with a cookie, are arranged in the shopping bag frame 302. That is to say, in this example, the purchaser has packed the bag with one piece of gum, two candies, and one cookie. As the purchaser presses a purchase button 310 in this state, the sales process described below is performed.

Referring back to FIG. 4, the merchandise information storing unit 62 stores information of merchandise items sold in the merchandise sales processing system 4. The merchandise piece storing unit 64 stores information of merchandise pieces. The shopping bag frame storing unit 66 stores information of the shopping bag frame. The user information storing unit 68 stores various kinds of user information of a user who is the purchaser. The condition storing unit 70 stores various conditions described below.

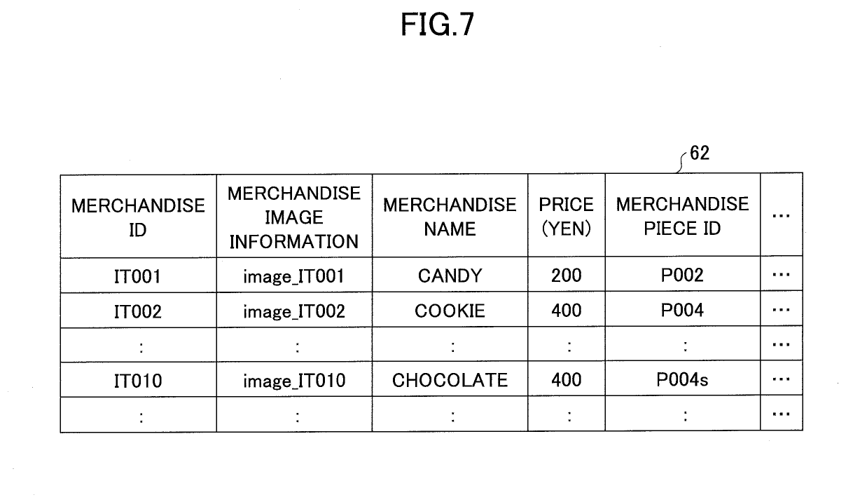

FIG. 7 illustrates an example of the internal structure of the merchandise information storing unit 62 of the embodiment. The merchandise information storing unit 62 includes items (fields) such as “merchandise ID”, “merchandise image information”, “merchandise name”, “price”, and “merchandise piece ID”.

The “merchandise ID” is identification information of the merchandise item. The “merchandise image information” is an image indicating the merchandise item. The merchandise image information corresponds to the merchandise images 308a through 308d illustrated in FIG. 5. The “merchandise name” is information of the name of the merchandise item. The “price” is information indicating the price of the merchandise item. The “merchandise piece ID” is identification information of the merchandise piece.

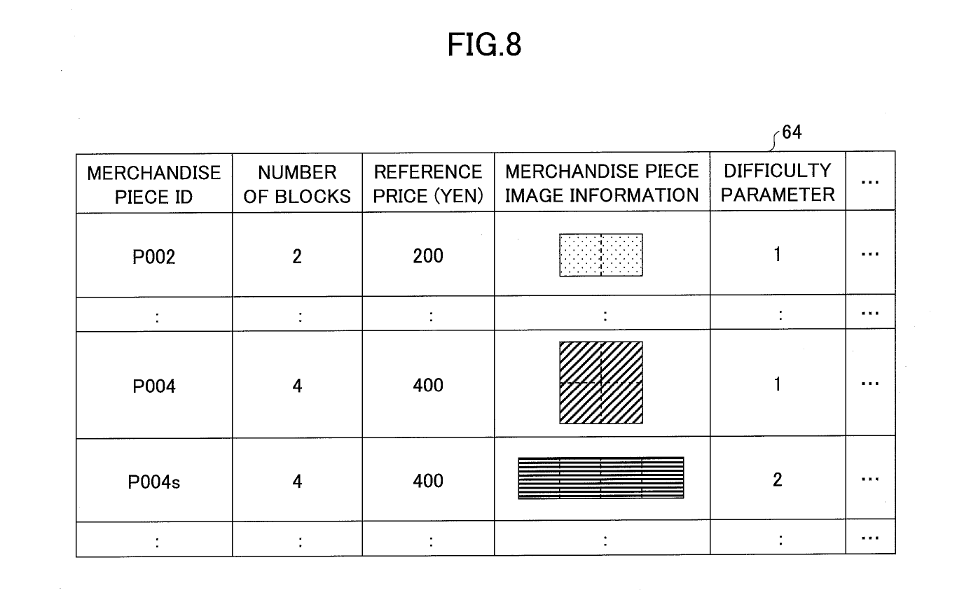

FIG. 8 illustrates an example of the internal structure of the merchandise piece storing unit 64 of the embodiment. The merchandise piece storing unit 64 includes items (fields) such as “merchandise piece ID”, “number of blocks”, “reference price”, “merchandise piece image information”, and “difficulty parameter”. The merchandise piece storing unit 64 may store information of a plurality of types of merchandise pieces of different shapes even though the number of blocks constituting each merchandise piece is the same.

The “merchandise piece ID” is identification information of a merchandise piece. The “number of blocks” is the number of blocks constituting the merchandise piece. The “reference price” is information indicating the reference price of the merchandise piece.

The “merchandise piece image information” is image information of the merchandise piece. The merchandise piece image information corresponds to the merchandise pieces 306a through 306d illustrated in FIG. 5. An image of a merchandise piece is constituted to include the number of blocks indicated in the “number of blocks” field.

The “difficulty parameter” is information of a parameter indicating the level of difficulty of arranging a merchandise piece in the shopping bag frame, according to the number of blocks included in the merchandise piece and the shape of the merchandise piece. In this example, it is assumed that the higher the value of the parameter, the higher the level of difficulty.

For example, in the illustrated example, each of the merchandise pieces of a merchandise piece ID “P004” and a merchandise piece ID “P004s” corresponds to four blocks; however, these merchandise pieces have different shapes. The arrangement of merchandise pieces depends on the shape of the shopping bag frame; in this example, in the shopping bag frame 302 in which blocks are arranged in a three-by-three matrix as illustrated in FIG. 5, it is possible to arrange the merchandise piece of the merchandise piece ID “P004”, but not the merchandise piece of the merchandise piece ID “P004s”. Thus, in this example, the merchandise piece of the merchandise piece ID “P004s” is set to have a higher difficulty parameter than that of the ID “P004”.

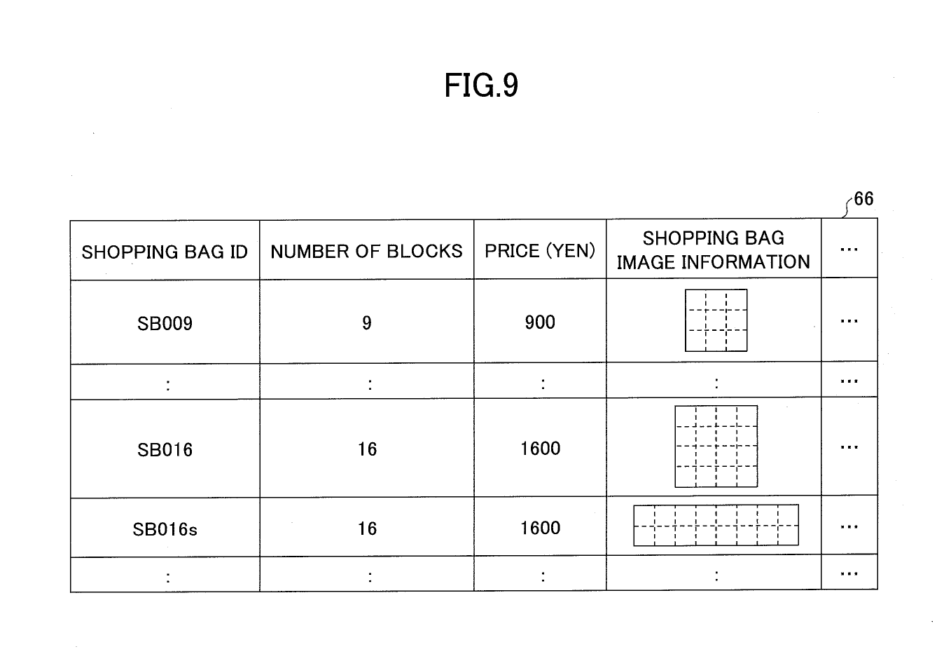

FIG. 9 illustrates an example of the internal structure of the shopping bag frame storing unit 66 of the embodiment. The shopping bag frame storing unit 66 includes items (fields) such as “shopping bag ID”, “number of blocks”, “price”, and “shopping bag image information”. Similar to the merchandise piece storing unit 64, the shopping bag frame storing unit 66 may store information of a plurality of types of shopping bag frames of different shapes, even though the number of blocks constituting each shopping bag frame is the same.

The “shopping bag ID” is identification information of the shopping bag frame. The “number of blocks” is the number of blocks constituting the shopping bag frame. The “price” is information indicating the price of the shopping bag frame. The “shopping bag image information” is image information of the shopping bag frame. The image of the shopping bag frame is constituted to include the number of blocks indicated in the “number of blocks” field.

Although not illustrated, similar to the merchandise piece storing unit 64, also in the shopping bag frame storing unit 66, the difficulty parameter indicating the level of difficulty of arranging the merchandise piece, may be stored in association with each shopping bag frame. Furthermore, the difficulty parameter of the merchandise piece illustrated in FIG. 8 is determined according to the relative relationship between the merchandise piece and the shape of the shopping bag frame, and therefore the merchandise piece storing unit 64 may store a difficulty parameter of a merchandise piece for each combination of a merchandise piece and a shopping bag frame.

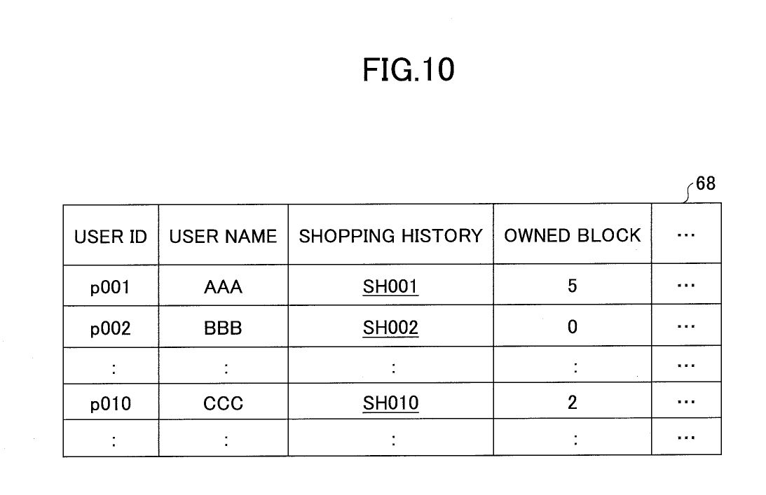

FIG. 10 illustrates an example of the internal structure of the user information storing unit 68 of the embodiment.

The user information storing unit 68 includes items (fields) such as “user ID”, “user name”, “shopping history”, and “owned block”.

The “user ID” is information for specifying (identifying) a user. The “user name” is information of a display name of the user. The “shopping history” is merchandise item purchase history information of the user. The “owned block” is information indicating the blocks held by the user. The “owned block” is described below.

Referring back to FIG. 4, the sales processing unit 48 performs a sales process for a merchandise item associated with the merchandise piece arranged in the shopping bag frame. For example, the sales processing unit 48 determines whether merchandise pieces have been arranged in all of the blocks in the shopping bag frame. When the sales processing unit 48 determines that merchandise pieces have been arranged in all of the blocks, the sales processing unit 48 asks the purchaser whether a payment is to be made. When the purchaser has given a purchase instruction, the sales processing unit 48 performs a sales process for a merchandise item such as making a payment. However, even when merchandise pieces have not been arranged in all of the blocks in the shopping bag frame, the sales processing unit 48 may perform a sales process for a merchandise item when the purchaser has given a purchase instruction. In the embodiment, the purchaser may purchase merchandise items within the range of merchandise pieces that can be arranged in the shopping bag frame 302.

In the embodiment, in one example, the sales price may be associated with the shopping bag frame. In this case, the presentation processing unit 44 displays the price of the shopping bag frame together with the shopping bag frame, and when a purchase instruction is received form the purchaser, the sales processing unit 48 performs a sales process by using the price associated with the shopping bag frame as the sales price of the merchandise item. Furthermore, the purchaser of merchandise may purchase a shopping bag frame in advance, and purchase merchandise items that can be arranged in the shopping bag frame.

In another example of the embodiment, the sales price may be associated with each merchandise item. In this case, the presentation processing unit 44 displays the price of the merchandise piece together with each merchandise piece, and when a purchase instruction is received from the purchaser, the sales processing unit 48 performs a sales process by using the total price associated with the merchandise pieces arranged in the shopping bag frame as the sales price of the merchandise.

Furthermore, the presentation processing unit 44 may display a plurality of shopping bag frame of different numbers of blocks and different shapes, and have the purchaser select one of the shopping bag frames.

Note that in the embodiment, one block may be configured to correspond to a predetermined value. A value is, for example, the price. In this case, for example, one block may be configured to correspond to a predetermined price such as 100 yen. Furthermore, the value is not limited to a price; the value may be set in consideration of the rarity value or the like.

As illustrated in FIG. 7, the vendor of the merchandise stores, in the merchandise information storing unit 62, the merchandise items sold by itself in association with merchandise pieces. In this case, the vendor may determine the merchandise piece with which the merchandise item is to be associated, in consideration of the price of the merchandise item, the reference price of the merchandise piece, and the difficulty parameter.

For example, by associating a merchandise item having a high value with a merchandise piece including many blocks, it is possible to increase the occupied area when the merchandise piece is arranged in the shopping bag frame. Furthermore, by associating a merchandise item having a high value with a merchandise piece having a complex shape, it is possible to make it difficult to arrange this merchandise piece in the shopping bag frame. The merchandise sales management unit 42 may receive such an instruction from the vendor, and store the instruction in the merchandise information storing unit 62.

Furthermore, when a predetermined discount condition is satisfied, the sales processing unit 48 may be configured to apply the discount on all merchandise pieces arranged in the shopping bag frame.

For example, the predetermined discount condition is that a discount piece is arranged in the shopping bag frame. In this case, the presentation processing unit 44 displays, on the merchandise sales screen, the discount piece having a predetermined shape corresponding to a predetermined number of blocks. Furthermore, in this case, the merchandise piece storing unit 64 may store, in addition to the merchandise piece, the information of the discount piece. The merchandise piece storing unit 64 stores a plurality of types of discount pieces that are set to apply a higher discount ratio as the number of blocks of the discount piece increases or the shape of the discount piece becomes more complex. The presentation processing unit 44 displays one or more discount pieces selected from among the plurality of types of discount pieces.

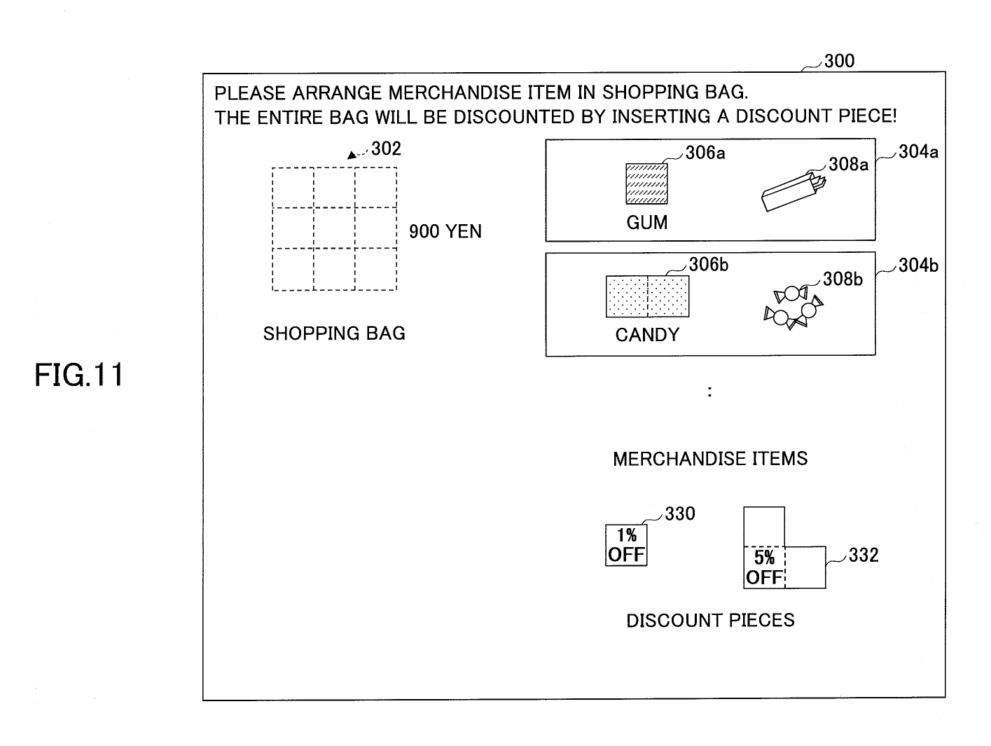

FIG. 11 illustrates another example of the merchandise sales screen 300 provided by the presentation processing unit 44 of the embodiment.

The merchandise sales screen 300 includes the shopping bag frame 302 and merchandise information items 304a through 304d having the same structures as those illustrated in FIG. 5, and further includes discount pieces 330 and 332, and a message saying “The entire bag will be discounted by inserting a discount piece!”.

The discount piece 330 and the discount piece 332 may be arranged in the shopping bag frame 302 by the same method as that of arranging the merchandise pieces. When the purchaser arranges the discount piece 330 or the discount piece 332 in the shopping bag frame 302 together with one of the merchandise pieces, and gives a purchase instruction, the sales processing unit 48 applies a discount on all merchandise pieces arranged in the shopping bag frame 302. The discount piece 330 is a 1% discount piece and the discount piece 332 is a 5% discount piece. For example, when the discount piece 330 is arranged in the shopping bag frame 302, the price of all of the merchandise pieces arranged in the shopping bag frame 302 becomes 1% off. That is to say, for example, when the price associated with the shopping bag frame is the sales price, the price associated with the shopping bag frame becomes 1% off. Furthermore, for example, when the total price associated with the merchandise pieces arranged in the shopping bag frame is the sales price of the merchandise items, the price becomes 1% off the total price.

Referring back to FIG. 4, the presentation processing unit 44 may display a plurality of discount pieces as illustrated in FIG. 11, or may display only one discount piece, or may display one of the discount pieces at random timings for each of the purchasers. Furthermore, when a plurality of discount pieces are displayed, the purchaser may arrange as many discount pieces as he/she wants in the shopping bag frame 302, or the purchaser may only be able to arrange less than or equal to a predetermined number of discount pieces in the shopping bag frame 302.

In another example, the discount condition may be that a combination of a plurality of predetermined merchandise items (merchandise pieces) is arranged in the shopping bag frame. The merchandise information storing unit 62 may store such combinations of merchandise items to which the discount condition is applicable.

Furthermore, in another example, the discount condition may be set in accordance with the number of merchandise pieces arranged in the shopping bag frame. The condition storing unit 70 may store such settings. The sales processing unit 48 may perform a sales process of merchandise items by applying the discount ratio associated with the number of merchandise pieces, based on the number of merchandise pieces arranged in the shopping bag frame. For example, the discount ratio may be increased when a large number of merchandise pieces are arranged in the shopping bag frame, and conversely, the discount ratio may be increased when a small number of merchandise pieces are arranged in the shopping bag frame.

The shape change processing unit 50 changes the predetermined shape of the shopping bag frame by moving some of the plurality of blocks in the shopping bag frame, under a predetermined condition. The predetermined condition may be, for example, a time service, a bargain sale, and a chance time.

Specifically, under the predetermined condition, the shape change processing unit 50 receives an instruction to move some of the plurality of blocks in the shopping bag frame from the purchaser, and changes the predetermined shape of the shopping bag frame by moving the blocks based on the instruction. In this example, the blocks that are the target of movement may be specified by the shape change processing unit 50 and presented to the purchaser, such that the purchaser may select the blocks. The movement destination may be selected by the purchaser. The shape change processing unit 50 moves some of the plurality of blocks based on the movement destination of some of the plurality of blocks specified by the purchaser.

At this time, the shape change processing unit 50 may change the predetermined shape of the shopping bag frame, such that the merchandise pieces that were unable to be arranged in the shopping bag frame before the change of shape, may be arranged in the shopping bag frame.

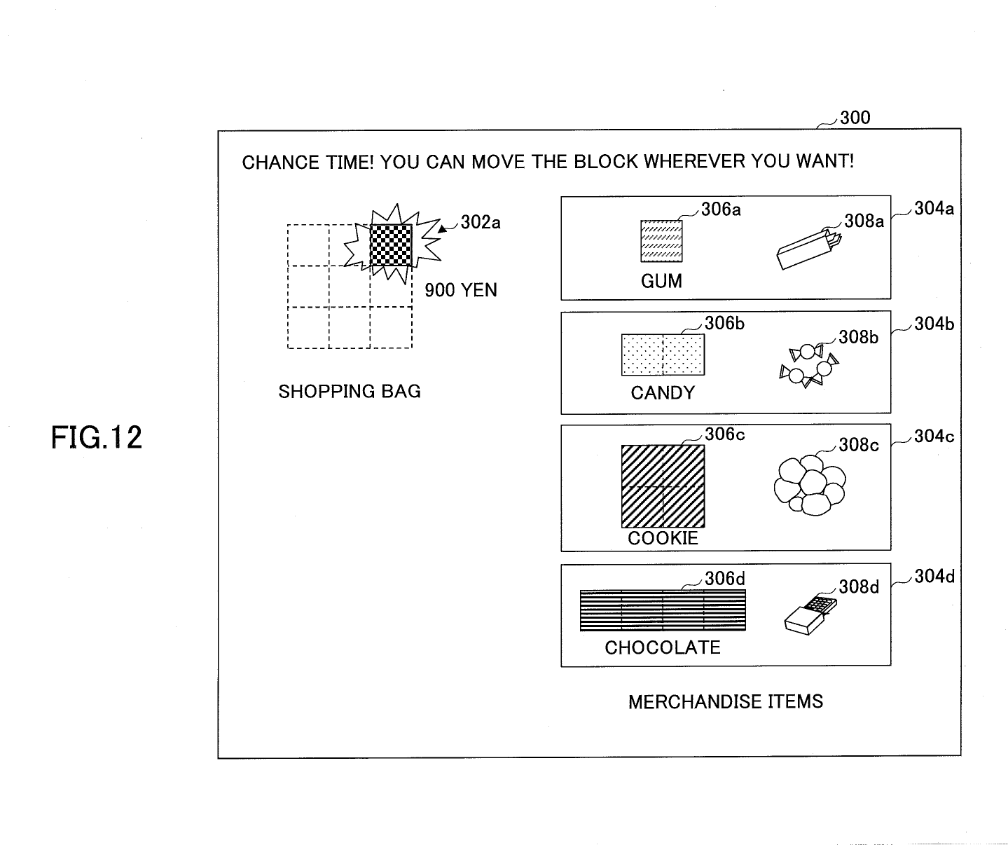

FIG. 12 illustrates another example of the merchandise sales screen 300 provided by the presentation processing unit 44 in the embodiment.

This example indicates a state where one block 302a, which is at the top right in the shopping bag frame 302 including nine blocks arranged in a three-by-three matrix, has become movable at a chance time. The merchandise sales screen 300 includes the shopping bag frame 302 and merchandise information items 304a through 304d having the same structures as those illustrated in FIG. 5, and further includes a message saying “Chance time! You can move the block wherever you want!”

When the purchaser moves the block 302a to a position adjacent to any one of the other blocks in the shopping bag frame 302, the shape change processing unit 50 receives this position as a specification of the movement destination, and moves the block 302a.

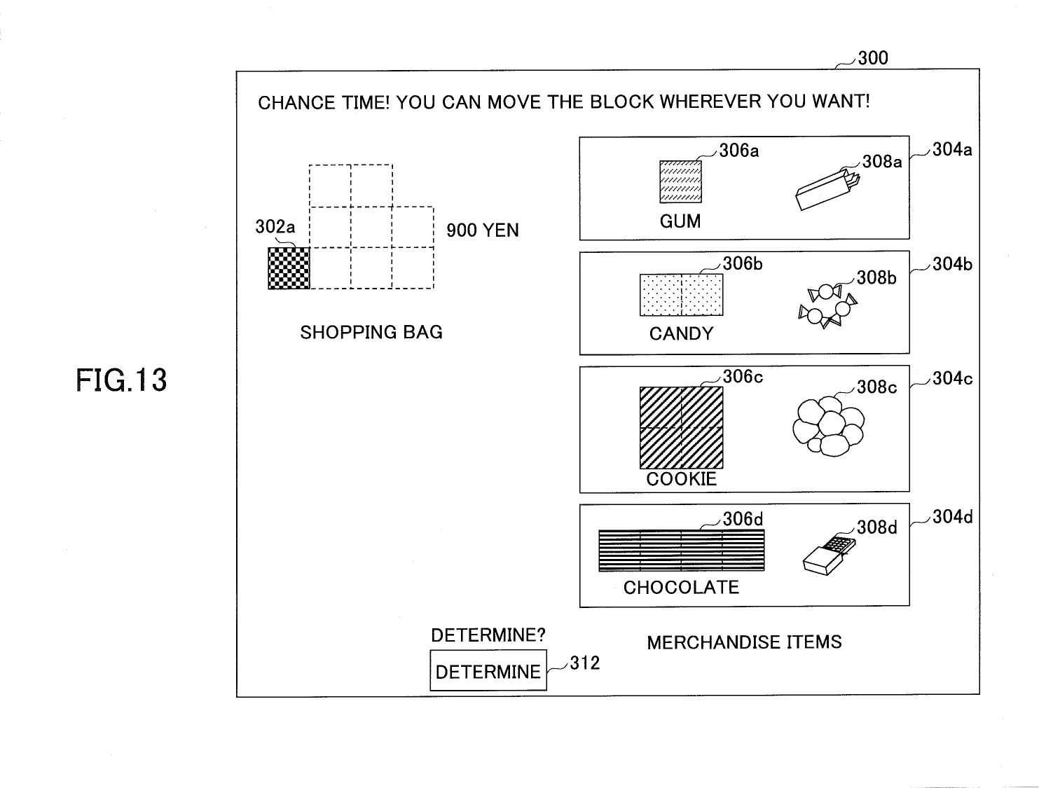

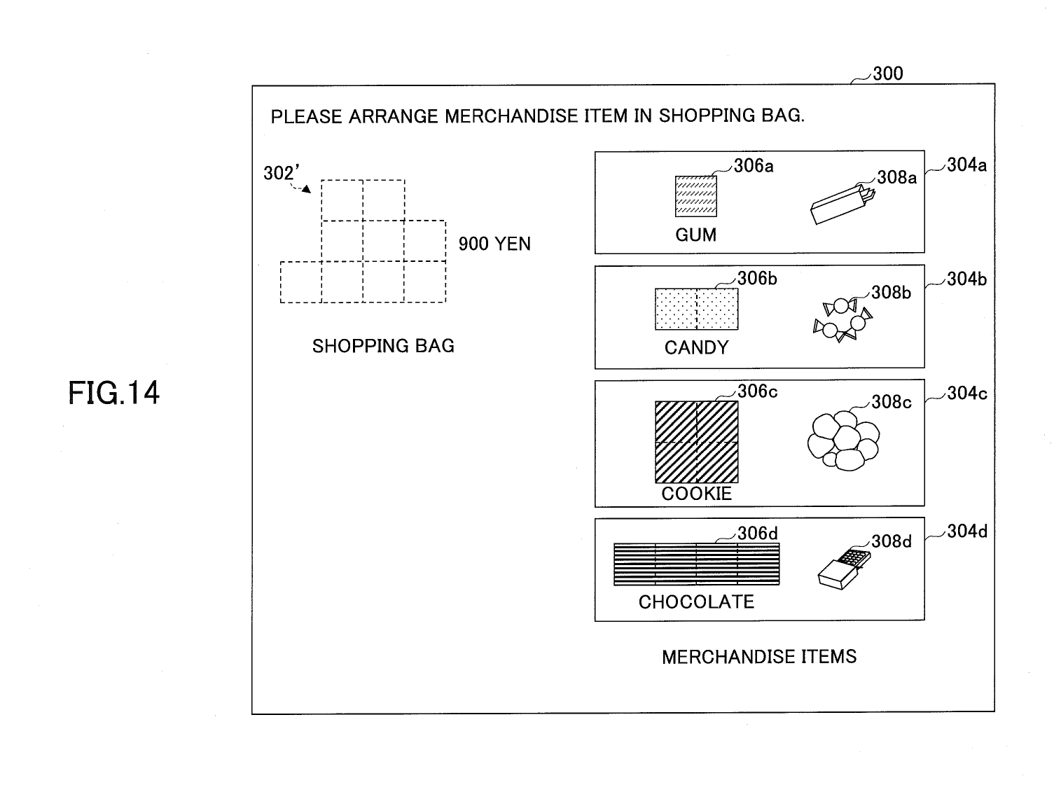

FIG. 13 illustrates a state where the block 302a has been moved. In this example, the block 302a is moved to the left edge in the bottommost row. Furthermore, the merchandise sales screen 300 includes a determine button 312. When the purchaser presses the determine button 312, the shape change processing unit 50 fixes the movement of the block 302a. Accordingly, as illustrated in FIG. 14, the shape of the shopping bag frame 302 changes, and becomes a shopping bag frame 302′.

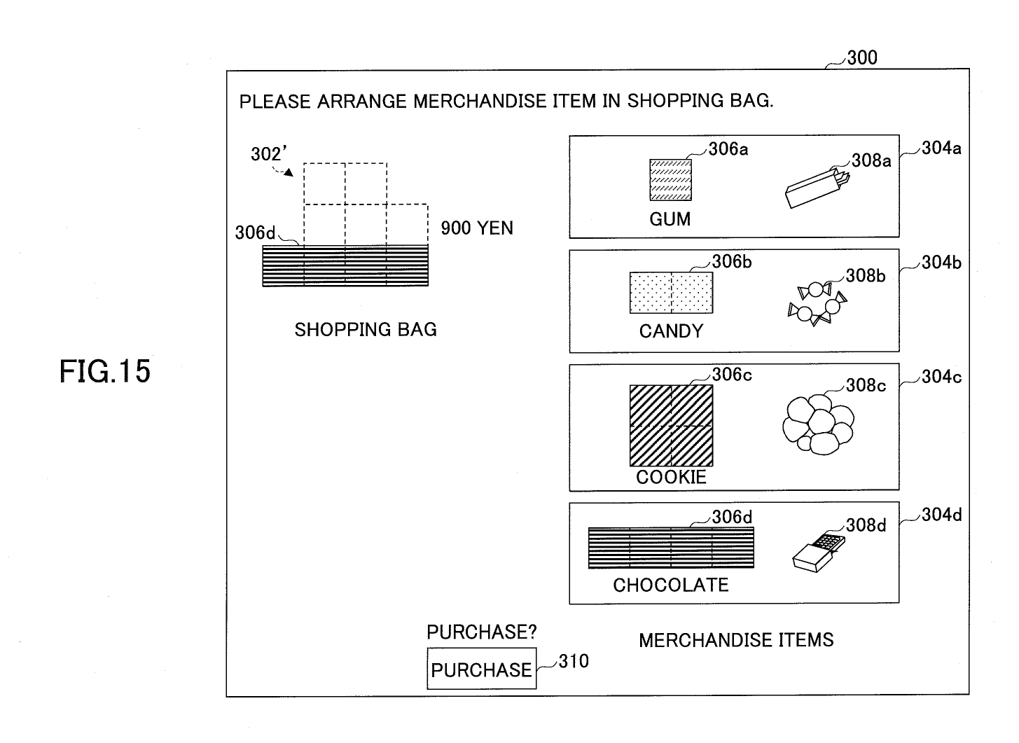

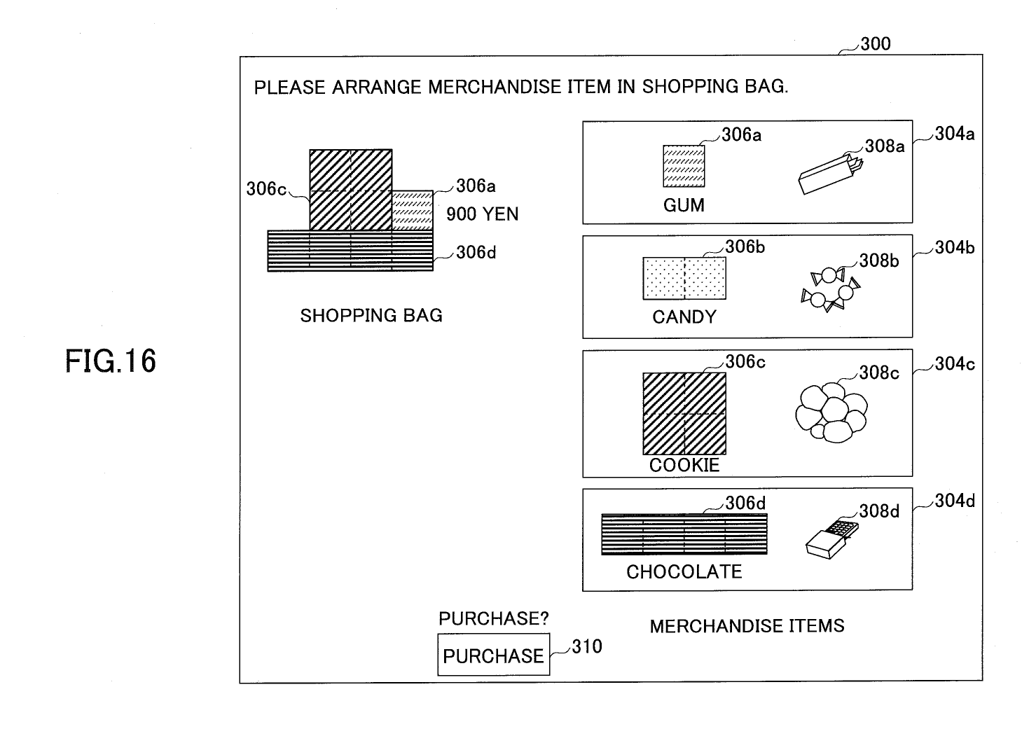

For example, in the shopping bag frame 302 having the shape as illustrated in FIG. 5, it is not possible to arrange the merchandise piece 306d associated with chocolate, in which four blocks are arranged in a row. However, by changing the shape of the shopping bag frame 302 to that of the shopping bag frame 302′, it is possible to arrange the merchandise piece 306d as illustrated in FIG. 15. Accordingly, as illustrated in FIG. 16, it is possible to purchase different merchandise items from those of the example illustrated in FIG. 6 using the shopping bag frame 302.

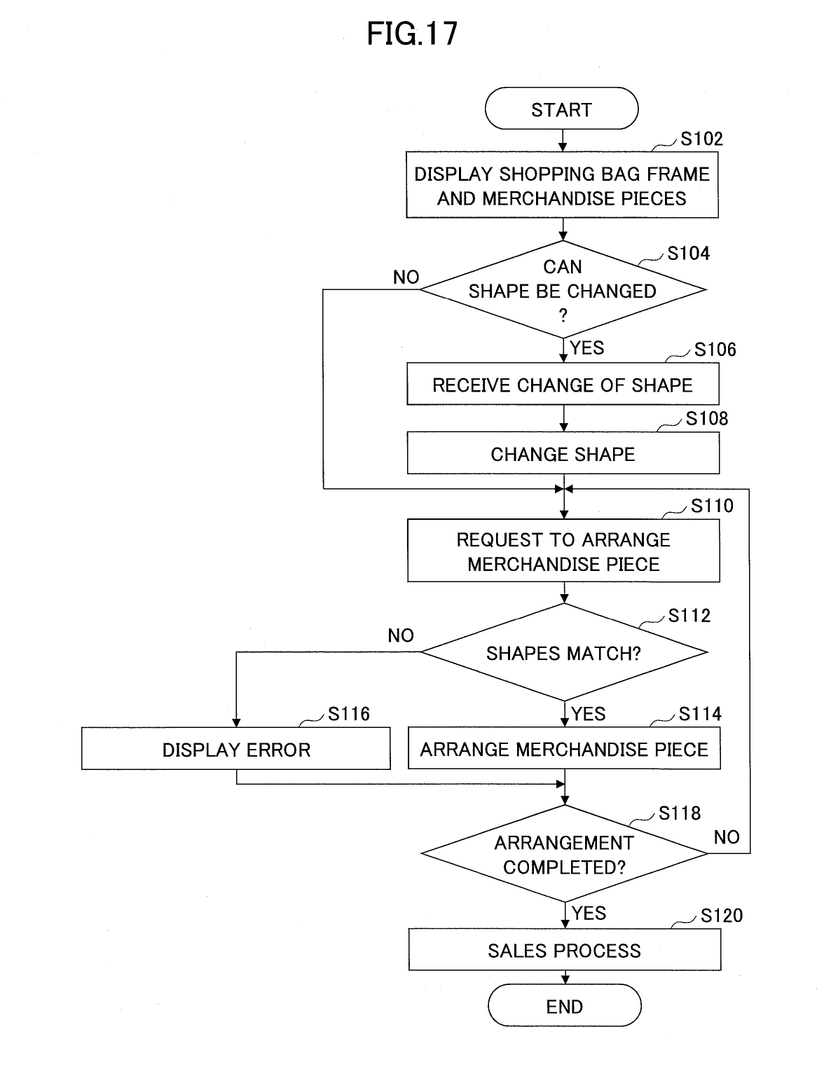

FIG. 17 is a flowchart of an example of processing procedures of the merchandise sales processing system 4 of the embodiment.

First, the presentation processing unit 44 displays, on the user terminal device 1 of the purchaser, a merchandise sales screen including the shopping bag frame 302 and merchandise pieces (step S102). Next, the shape change processing unit 50 determines whether the shape of the shopping bag frame can be changed (step S104). When the shape of the shopping bag frame can be changed (YES in step S104), the shape change processing unit 50 receives, from the purchaser via the user terminal device 1, a specification of the movement destination of the block that is a movement target, and changes the shape of the shopping bag frame (steps S106 and S108).

Next, when a request is received, from the purchaser via the user terminal device 1, to arrange one of the merchandise pieces at a predetermined position where no other merchandise pieces are arranged in the shopping bag frame (step S110), the merchandise piece arrangement processing unit 46 determines whether the shape of this merchandise piece matches the shape of the predetermined position (step S112). When the shapes match (YES in step S112), the merchandise piece arrangement processing unit 46 arranges the merchandise piece at the predetermined position (step S114). Meanwhile, when the shapes do not match (NO in step S112), the merchandise piece arrangement processing unit 46 displays an error (step S116). Note that when a discount piece is displayed on the merchandise sales screen, in step S110, the discount piece may be arranged in the shopping bag frame, similar to the merchandise piece.

The same process as above is repeated until the arrangement of merchandise pieces in the shopping bag frame is completed, i.e., until, for example, the purchaser gives a purchase instruction. When the arrangement of merchandise pieces in the shopping bag frame is completed (YES in step S118), the sales processing unit 48 performs the sales process (step S120). In this example, when a predetermined discount condition is applied, the sales processing unit 48 also performs a discount process.

According to the embodiment, by the above configuration, a technique capable of providing the customer with enjoyment in the process of purchasing merchandise when shopping online, can be provided.

Note that the respective components in the user terminal device 1 and the merchandise sales processing system 4 illustrated in FIG. 4 do not indicate hardware units, but the components indicate blocks of functional units. The components in the user terminal device 1 and the merchandise sales processing system 4 may be embodied by arbitrary combinations of hardware and software, typified by a CPU of an arbitrary computer, a memory, a program loaded in the memory so as to embody the constituents illustrated in the drawings, a storage unit for storing the program such as a hard disk, and an interface for network connection. It may be understood by those skilled in the art that methods and devices for the embodiment allow various modifications. Further, functions performed by the merchandise sales processing system 4 may be unnecessarily actualized in a single apparatus and may be distributed in a plurality of apparatuses.

Although a preferred embodiment has been specifically illustrated and described, it is to be understood that minor modifications may be made therein without departing from the spirit and scope of the invention as defined by the claims.

For example, at the time of purchasing merchandise in the past, when no merchandise pieces were arranged in a block in the shopping bag frame when the sales processing unit 48 performed the sales process of merchandise, this block may be used in the next time of shopping for merchandise. In this case, the sales processing unit 48 stores the block in which no merchandise pieces were arranged, in association with a purchaser, as an “owned block” of the purchaser, in the user information storing unit 68. When the purchaser purchases merchandise the next time, the shape change processing unit 50 adds this block to the present shopping bag frame to change the predetermined shape of the shopping bag frame.

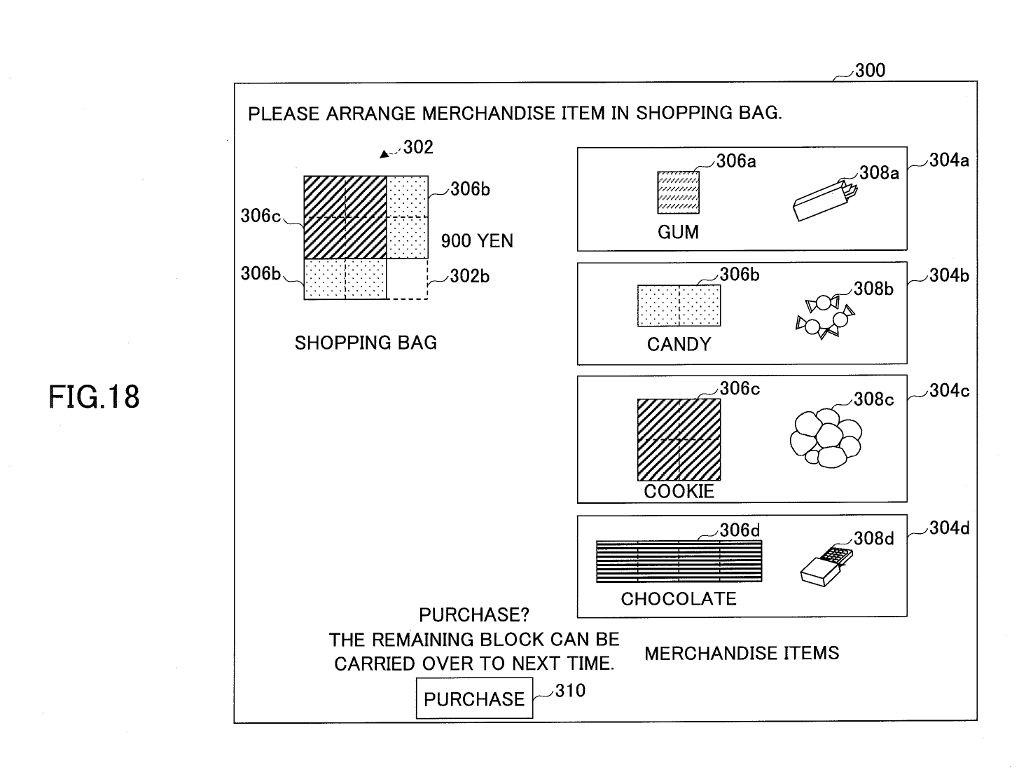

FIG. 18 illustrates another example of the merchandise sales screen 300 provided by the presentation processing unit 44. This example illustrates a state where no merchandise pieces are arranged in the block 302b in the shopping bag frame 302. Furthermore, the merchandise sales screen 300 includes a message saying “The remaining block can be carried over to next time”. When the purchaser gives a purchase instruction in this state, the sales processing unit 48 stores the block 302b in the user information storing unit 68 in association with the purchaser as an “owned block” of the purchaser.

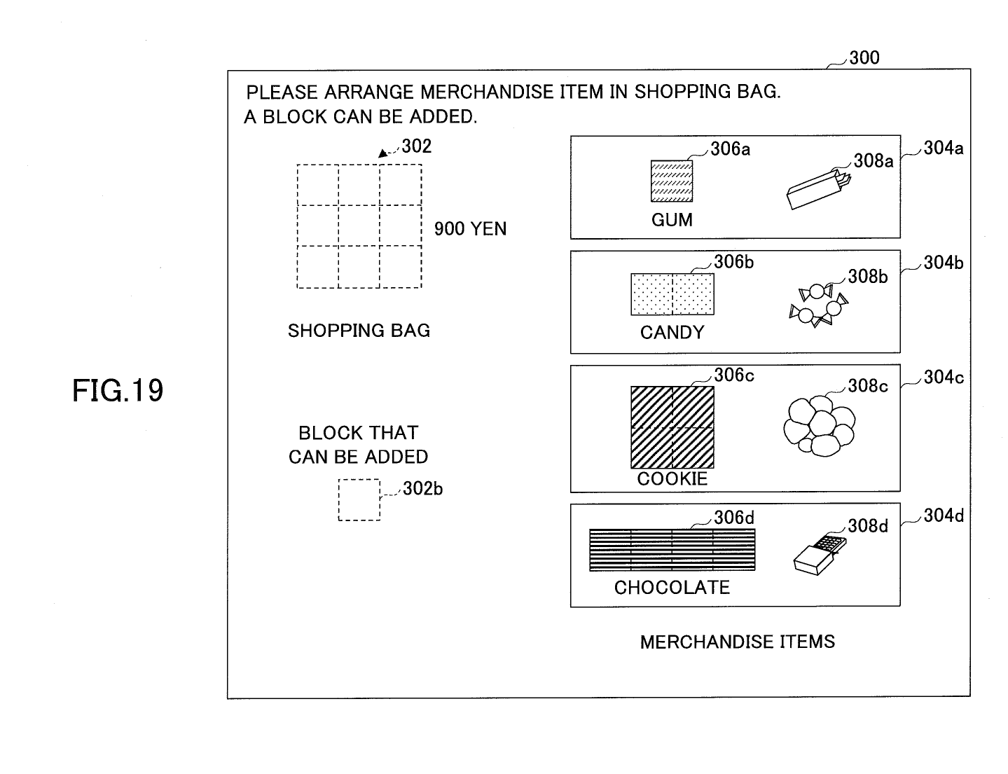

FIG. 19 illustrates an example of the merchandise sales screen 300 provided by the presentation processing unit 44 when the purchaser newly purchases merchandise. In this example, the merchandise sales screen 300 includes a message saying “A block can be added”, and the block 302b that can be added.

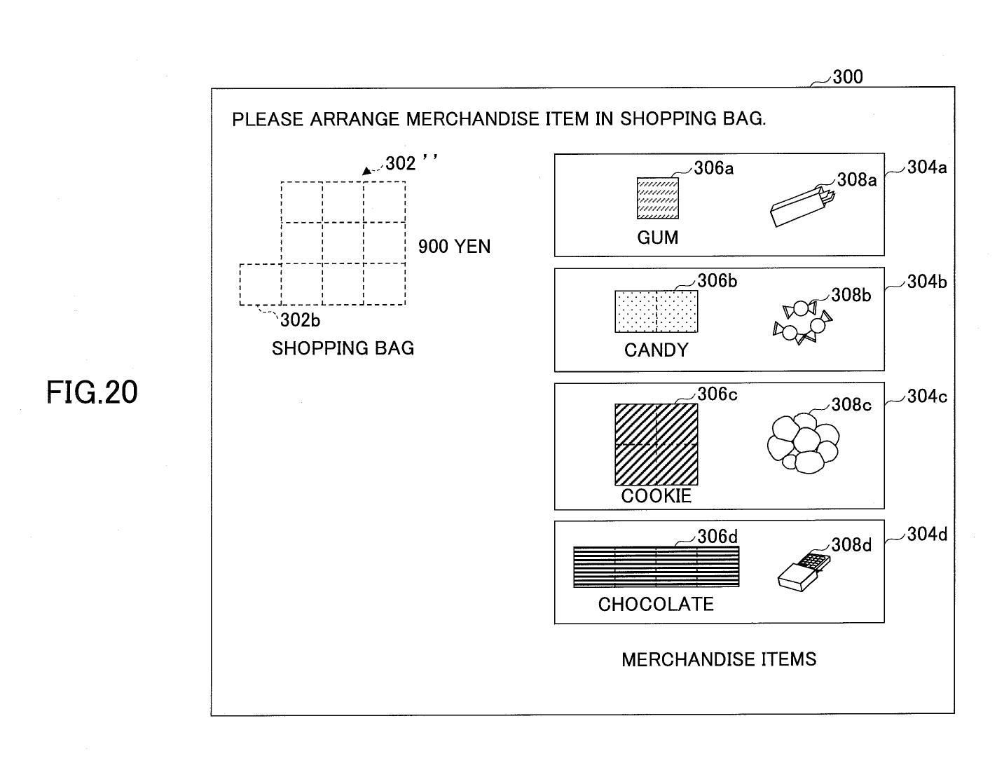

When the purchaser moves the block 302b to a position adjacent to any one of the other blocks in the shopping bag frame 302, the shape change processing unit 50 receives this position as a specification of the adding destination, and adds the block 302b. FIG. 20 illustrates a state where the block 302b has been added. In this example, the block 302b is added to the left edge in the bottommost row. Accordingly, the shape of the shopping bag frame 302 changes, and becomes a shopping bag frame 302″.

Note that the “owned block” of the purchaser is not limited to a block that was not used in the previous shopping by the purchaser; for example, an “owned block” may be provided as a gift from the vendor.

Furthermore, in another example, under a predetermined condition, the shape change processing unit 50 may move some of a predetermined number of blocks of a merchandise piece, and change the predetermined shape of the merchandise piece. This procedure may be the same as the process of changing the shape of the shopping bag frame.

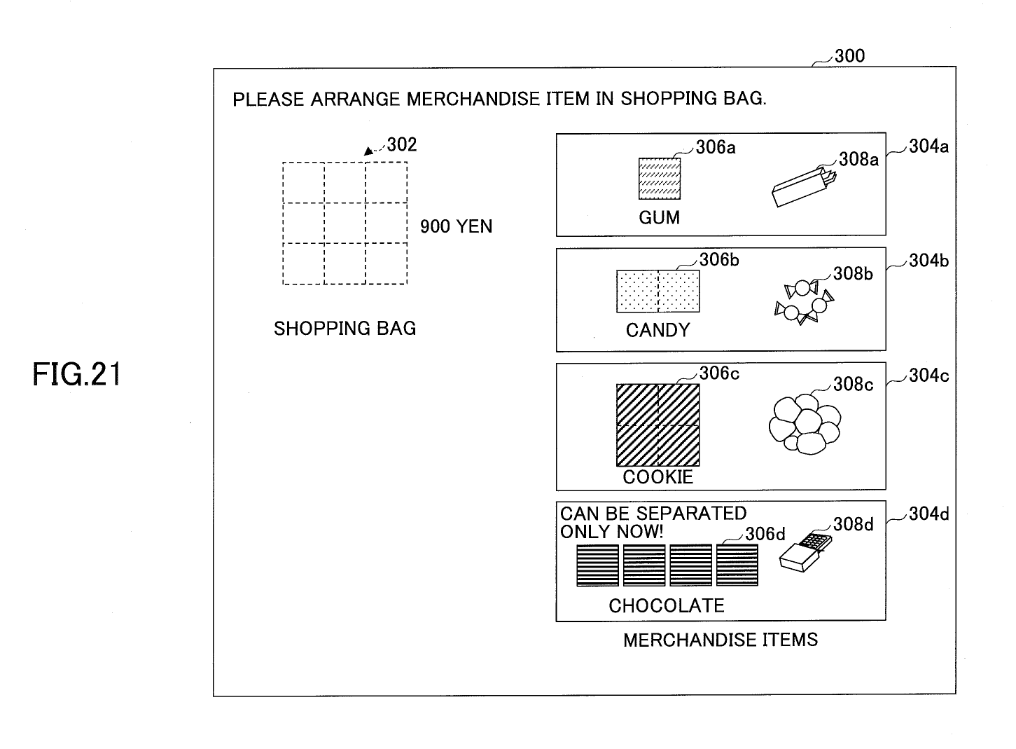

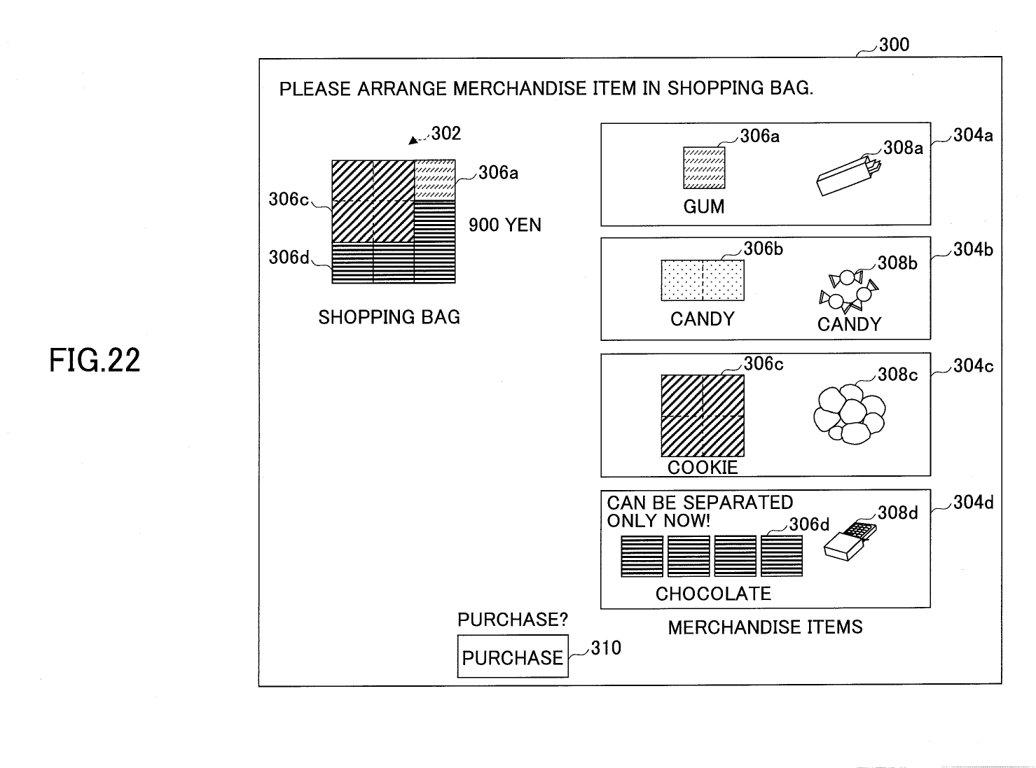

Furthermore, in another example, under a predetermined condition, the presentation processing unit 44 may display some of or all of a predetermined number of blocks of a merchandise piece in a separated state on the merchandise sales screen 300. FIG. 21 illustrates another example of the merchandise sales screen 300 indicating this state. In this example, as described with reference to FIG. 5, the merchandise piece 306d associated with chocolate has a shape in which four blocks are arranged in a row. However, in the example illustrated in FIG. 21, these four blocks are separated into individual blocks. By the above configuration, as illustrated in FIG. 22, the purchaser can arrange the respective blocks at desired positions in the shopping bag frame 302, and therefore the chocolate corresponding to the merchandise piece 306d can be purchased without changing the shape of the shopping bag frame 302.

Furthermore, in another example, a plurality of purchasers can make a joint purchase of merchandise items arranged in a single shopping bag frame. In this case, the merchandise piece arrangement processing unit 46 receives requests to arrange merchandise pieces from the plurality of purchasers with respect to a single shopping bag frame, and the sales processing unit 48 manages each of the merchandise pieces arranged in the shopping bag frame in association with identification information of the purchaser who had made the request to arrange the corresponding merchandise piece. Based on the merchandise item associated with the merchandise piece arranged in the shopping bag frame and identification information of a purchaser, the sales processing unit 48 performs a sales process of the merchandise item, to be purchased by the purchaser identified by the identification information.

Furthermore, in another example, even when part of the merchandise piece is sticking out from the shopping bag frame, under a predetermined condition, this merchandise piece may be purchased. For example, the predetermined condition is that the ratio of the area of the merchandise piece that is sticking out is within a predetermined ratio with respect to the area of the shopping bag frame 302 (for example, a relatively low ratio such as within 5%), and that the purchaser has made the payment within a predetermine time from when the purchaser has finished arranging the merchandise piece in the shopping bag frame (for example, a relatively short time such as within five minutes). This is derived from the concept that when packing a bag in a real store, an item can be packed in the bag by stretching the bag to some extent, unless the bag is torn.

Furthermore, in the above embodiment, a description is given of an example where goods such as gum and candy are the merchandise items; however, the merchandise item may be an intangible object such as a service.

Furthermore, in the above embodiment, a description is given of an example where the shopping bag frame and the merchandise pieces have a two-dimensional structure; however, these may have a three-dimensional structure.

Furthermore, in the above embodiment, a description is given of an example where the shape change processing unit 50 changes the shape of the shopping bag frame based on an instruction from the purchaser to move some of the plurality of blocks in the shopping bag frame; however, for example, the shape change processing unit 50 may change the shopping bag frame into an arbitrary shape at a predetermined timing such as a change time.

Furthermore, the relative relationship between the shopping bag frame and the merchandise piece may be rotatable; the shopping bag frame or the merchandise piece maybe rotated by a gyro acceleration sensor.

What is claimed is:

1. A merchandise sales processing system comprising:
a presentation processing unit that presents
a shopping bag frame having a predetermined shape corresponding to a plurality of blocks, and
a plurality of merchandise pieces respectively associated with merchandise items, each of the plurality of merchandise pieces corresponding to a predetermined number of the plurality of blocks and having a predetermined shape unrelated to the corresponding merchandise item;
a merchandise piece arrangement processing unit that receives, from a purchaser, a request to arrange one of the plurality of merchandise pieces at a predetermined position to which no other ones of the plurality of merchandise pieces are arranged in the shopping bag frame, and arranges the one of the plurality of merchandise pieces at the predetermined position when a shape of the one of the plurality of merchandise pieces matches a shape of the predetermined position; and
a sales processing unit that performs a sales process for at least one of the merchandise items associated with at least one of the plurality of merchandise pieces arranged in the shopping bag frame.

2. The merchandise sales processing system according to claim 1, further comprising:
a shape change processing unit that changes the predetermined shape of the shopping bag frame by moving at least one of the plurality of blocks in the shopping bag frame, under a predetermined condition.

3. The merchandise sales processing system according to claim 2,
wherein the shape change processing unit moves at least one of the plurality of blocks based on a movement destination of at least one of the plurality of blocks specified by the purchaser, under the predetermined condition.

4. The merchandise sales processing system according to claim 2,
wherein the shape change processing unit changes the predetermined shape of the shopping bag frame such that one of the plurality of merchandise pieces, which cannot be arranged in the shopping bag frame before the change of the predetermined shape of the shopping bag frame, can be arranged in the shopping bag frame.

5. The merchandise sales processing system according to claim 1, further comprising:
a shape change processing unit that changes the predetermined shape of the shopping bag frame by adding, to the shopping bag frame of a present time of purchasing merchandise, at least one of the plurality of blocks in which none of the plurality of merchandise pieces were arranged in the shopping bag frame when the sales processing unit performed the sales process at a past time of purchasing merchandise.

6. The merchandise sales processing system according to claim 1, further comprising:
a shape change processing unit that changes the predetermined shape of one of the plurality of merchandise pieces by moving at least one of the predetermined number of the plurality of blocks of the one of the plurality of merchandise pieces, under a predetermined condition.

7. The merchandise sales processing system according to claim 1,
wherein the sales processing unit applies a discount on all of the plurality of merchandise pieces arranged in the shopping bag frame, when a predetermined discount condition is satisfied.

8. The merchandise sales processing system according to claim 7,
wherein the predetermined discount condition is that a combination of predetermined ones of the plurality of merchandise pieces is arranged in the shopping bag frame.

9. The merchandise sales processing system according to claim 7,
wherein the presentation processing unit also displays a discount piece having a predetermined shape corresponding to a predetermined number of the plurality of blocks, and
the predetermined discount condition is that the discount piece is arranged in the shopping bag frame.

10. The merchandise sales processing system according to claim 9,
wherein the presentation processing unit displays at least one discount piece selected from among a plurality of types of the discount pieces that are set to apply a higher discount ratio as the predetermined number of the plurality of blocks of the discount piece increases or the predetermined shape of the discount piece becomes more complex.

11. The merchandise sales processing system according to claim 1,
wherein the sales processing unit performs the sales process for at least one of the merchandise items, by applying a discount ratio set in accordance with a number of at least one of the plurality of merchandise pieces arranged in the shopping bag frame.

12. The merchandise sales processing system according to claim 1,
wherein the merchandise piece arrangement processing unit receives the request to arrange one of the plurality of merchandise pieces from each of a plurality of the purchasers with respect to a single one of the shopping bag frame, and
the sales processing unit manages at least one of the plurality of merchandise pieces arranged in the shopping bag frame in association with identification information of one of the plurality of the purchasers who has made the request to arrange at least one of the plurality of merchandise pieces.

13. The merchandise sales processing system according to claim 12,
wherein the sales processing unit performs the sales process for at least one of the merchandise items associated with at least one of the plurality of merchandise pieces arranged in the shopping bag frame, when a purchase instruction is given by one of the plurality of the purchasers or when at least one of the plurality of merchandise pieces is arranged in all of the plurality of blocks in the shopping bag frame.

14. The merchandise sales processing system according to claim 12,
wherein the sales processing unit performs the sales process for at least one of the merchandise items to be purchased by one of the plurality of the purchasers identified by the identification information, based on at least one of the merchandise items associated with at least one of the plurality of merchandise pieces arranged in the shopping bag frame and the identification information of one of the plurality of the purchasers.

15. The merchandise sales processing system according to claim 1,
wherein the presentation processing unit displays a price of the shopping bag frame together with the shopping bag frame, and
the sales processing unit performs the sales process by using the price associated with the shopping bag frame as a sales price of at least one of the merchandise items.

16. The merchandise sales processing system according to claim 1,
wherein the presentation processing unit displays prices of the plurality of merchandise pieces together with the plurality of merchandise pieces, and
the sales processing unit performs the sales process by using a total amount of the prices associated with at least one of the plurality of merchandise pieces arranged in the shopping bag frame.

17. The merchandise sales processing system according to claim 1,
wherein each of the plurality of blocks corresponds to a predetermined price.

18. A non-transitory computer-readable recording medium storing a program for a merchandise sales processing system, wherein the program causes a computer to execute a process, the process comprising:
presenting a shopping bag frame having a predetermined shape corresponding to a plurality of blocks, and a plurality of merchandise pieces respectively associated with merchandise items, each of the plurality of merchandise pieces corresponding to a predetermined number of the plurality of blocks and having a predetermined shape unrelated to the corresponding merchandise item;
receiving, from a purchaser, a request to arrange one of the plurality of merchandise pieces at a predetermined position to which no other ones of the plurality of merchandise pieces are arranged in the shopping bag frame, and arranging the one of the plurality of merchandise pieces at the predetermined position when a shape of the one of the plurality of merchandise pieces matches a shape of the predetermined position; and
performing a sales process for at least one of the merchandise items associated with at least one of the plurality of merchandise pieces arranged in the shopping bag frame.
